(19) United States
(12) Patent Application Publication
(10) Pub. No.: US 2025/0071164 A1
(43) Pub. Date: Feb. 27, 2025

(54) ADAPTIVE STREAMING OF MULTIMEDIA CONTENT

(71) Applicant: Sony Interactive Entertainment Europe Limited, London (GB)

(72) Inventors: Maurizio CERRATO, London (GB); Rajeev GUPTA, London (GB); Christopher William HENDERSON, London (GB); Marina VILLANUEVA-BARREIRO, London (GB); Jesus Lucas BARCIAS, London (GB); Marcos CONDE, London (GB); Matthew William SANDERS, London (GB); Rosario LEONARDI, London (GB)

(73) Assignee: Sony Interactive Entertainment Europe Limited, London (GB)

(21) Appl. No.: 18/809,809

(22) Filed: Aug. 20, 2024

(30) Foreign Application Priority Data
Aug. 21, 2023 (GB) 2312737.6

(51) Int. Cl. H04L 65/75

(52) U.S. Cl. CPC H04L 65/762

(57) ABSTRACT

The present disclosure describes a method and system for adaptively streaming multimedia content. Data relating to the multimedia content is separated into a plurality of components, each of the components corresponding to one or more features of the multimedia content. The plurality of components are prepared for transmission to a client device, wherein a different preparation is applied to each component depending on the one or more features of a respective component. The prepared components are transmitted from the server to the client device.

### CROSS-REFERENCE TO RELATED APPLICATIONS

The present application claims priority from British Patent Application No. 2312737.6, filed Aug. 21, 2023, the contents of which are incorporated herein by reference in its entirety.

### FIELD

The present disclosure relates to a method and system for streaming multimedia content. In particular, the present disclosure provides adaptive streaming of multimedia content that is particularly suited to gaming applications in distributed systems, for example including cloud gaming.

### BACKGROUND

Streaming high quality multimedia content is becoming increasingly demanding and resource intense. There are expectations to be met about the quality of multimedia content provided to players of games. This requires generating and rendering scenes quickly and effectively to avoid delays between user input and an output displayed to the user. Handling large amounts of data to provide high quality user experience can cause these delays. Due to their dependency on high-quality streaming video, cloud gaming services often require reliable, high-speed internet connections with low latency. Even with high-speed connections available, traffic congestion and other issues affecting network latency can affect the performance of cloud gaming.

Accordingly, there is a need for methods of streaming content which optimises resources available to facilitate high quality user experience.

### SUMMARY

According to a first aspect, there is provided a method of streaming multimedia content performed at a server. The method comprises separating data relating to the multimedia content into a plurality of components, each of the components corresponding to one or more features of the multimedia content. The method further comprises preparing the plurality of components for transmission to a client device, wherein a different preparation is applied to each component depending on the one or more features of a respective component. The method further comprises transmitting the prepared components from the server to the client device.

Advantageously, the method allows streaming the content in an optimised manner. Separating the data into a plurality of components allows for distributed processing of the component parts that make up the multimedia content. Computer resources can be saved based on the different preparation applied to each component before being transmitted to the client device, or can be directed to the more “important” parts of the multimedia content for producing the perceived effect of higher quality. The multimedia content generated and streamed in the present disclosure is for instantaneous, or near instantaneous, display at the client device with improved latency compared to prior art techniques.

The data comprising the multimedia content may correspond to a scene in a video game, for example. In some embodiments, the multimedia content may be gameplay. The data and/or features of the multimedia content may correspond to one or more of: sound data, image data, animation data, saliency data etc.

Transmitting may occur across a network, for example a communications network such as the internet.

Multimedia content may comprise multiple components, each component representing a sub-section of data of the media content.

Preparing may comprise processing of the data into a transmissible format. Preparing can include several different processes to be applied to the data for transmission.

In some embodiments, preparing the components for transmission may comprise applying a different data compression ratio to the data of each of the plurality of components. Each of the components can therefore be compressed at a different rate, for example depending on the type of data comprised in each component or on the importance of the data in each component.

In some embodiments, preparing the components for transmission may comprise rendering an image based on the data of the respective component, wherein rendered images of the plurality of components each have a different resolution. Rendering may include partial rendering. Rendering the components at different resolutions may be advantageous depending on how a user will eventually experience a respective component in the multimedia content. Lower resolutions may be applied to images that are not in a direct view of a user and vice versa.

In some embodiments, preparing the components for transmission may comprise adding information to a transmission packet concerning the respective component to the plurality of components. Information may include positional information of the component (e.g. relative to other components), rendering information for that component, and/or information that can be used by the client when reconstructing the content for display.

Preparing may additionally comprise encoding and/or encrypting the data to be transmitted.

In some embodiments, the method may further comprise transmitting a message from the server to the client device comprising information on how to construct the multimedia content at the client device. The message can be sent separately to the components. The information may comprise information on how to process the components at the client device and complete the multimedia content for display to a user.

In some embodiments, the plurality of components may comprise one or more of: a foreground component comprising features for display in a foreground of the multimedia content, a midground component comprising features for display in a midground of the multimedia content, and/or a background component comprising features for display in a background of the multimedia content.

In some embodiments, the plurality of components may comprise: a static component comprising static features; and a dynamic component comprising dynamic features. Optionally, wherein the static component is rendered at the server and the dynamic component is transmitted to the client device for rendering at the client device. Dynamic features may include moving parts of an image within an image stream of the media content. The static component rendered at the sever may additionally be compressed and encoded at the server before transmission to the client device.

In some embodiments, the method may further comprise assigning a priority to each one of the plurality of components and preparing the components for transmission based on their assigned priorities. Priorities may be determined to indicate which of the components is more “important”, for example if the bandwidth available for transmission is below a predetermined level more important components may be transmitted, whilst less important components may not be transmitted.

Optionally, computing resources may be allocated to the components based on an assigned priority of the component. For example, rendering the components at different resolutions based on the priority status of the component, or compressing the components based on the priority status.

In some embodiments, the method may further comprise receiving, at the client device, the components of the multimedia content; and constructing the multimedia content at the client device.

In some embodiments, constructing comprises one or more of: decrypting, decompressing, decoding, repositioning and rendering the plurality of components.

In some embodiments, the method may further comprise applying post-processing effects to the constructed multi-media content. For example, comprising applying lighting effects to a scene once the entire scene has been constructed.

In some embodiments, the method may further comprise predicting, at the client device, data relating to components that are not received at the client device. Predictions may be based on previous frames for example.

In some embodiments, the preparation may depend on a bandwidth available between the server and the client device. For example, some components may not be sent across because of poor bandwidth, or not received at the client device for some other reason.

In some embodiments, each of the components may be transmitted using a different codec.

According to a second aspect, there is provided a server comprising a memory; and one or more processors configured to implement the method according to the first aspect. Optionally, wherein the server is cloud-based.

### BRIEF DESCRIPTION OF DRAWINGS

A more complete understanding of the subject matter may be derived by referring to the detailed description and claims when considered in conjunction with the following figures, wherein like reference numbers refer to similar elements throughout the figures.

FIG. 1 illustrates a flow diagram of a method for adaptive encoding for streaming media content according to an embodiment of the disclosure;

FIG. 2 illustrates schematically an example of a cloud gaming system that may be used in accordance with the present disclosure;

FIG. 3 illustrates an image of a scene from a frame of streamed multimedia content;

FIG. 4 illustrates a block diagram of one example implementation of a computing device that can be used for implementing a method according to an embodiment of the disclosure.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

There is described herein methods for adaptive streaming of multimedia content. Multimedia content refers to a combination of media elements including text, images, audio, video and interactive elements that together form a user environment, such as a scene in a video game, to be experienced by a user. The present disclosure is particularly suited to cloud gaming, where multimedia content, for example corresponding to a game, can be streamed from a remote server to a local client device. Games are stored and executed remotely on a provider's dedicated hardware and streamed as video to a player's device via client software. Software at the client device handles user inputs, which can be sent back to the server and executed in-game. Cloud gaming can be made available on a wide range of computing devices, including mobile devices such as smartphones and tablets, digital media players, or proprietary thin client-like devices due to reduced reliance on local computer infrastructure for running games completely locally at a user's device.

The present disclosure allows streaming multimedia content in an optimised manner by separating the data relating to the multimedia content into a plurality of components for streaming. This allows for distributed processing of the components that make up the multimedia content which can help to improve streamlining of the process. Prior to streaming, the streaming content is separated into respective components and each component can be treated slightly differently before being transmitted to the client. Components can then be reconstructed at the client device for display to a user. Computer resources at the client (and the server) can be saved based on the different preparation applied to each component before being transmitted to the client device. Latency can be improved by distributing the work between the server and the client for a given frame or series of frames in the multimedia content. The server may have more resources available for processing aspects of the multimedia content, however, losses can be made in transmitting the multimedia content from the server to the client. Adaptively processing data and distributing tasks can help to generate high quality user experience and improve latency.

The multimedia content is generated and streamed in real-time based, for example, on user inputs whilst playing the game. Reducing the time between generation at the server and display at the client device is aided by the present disclosure.

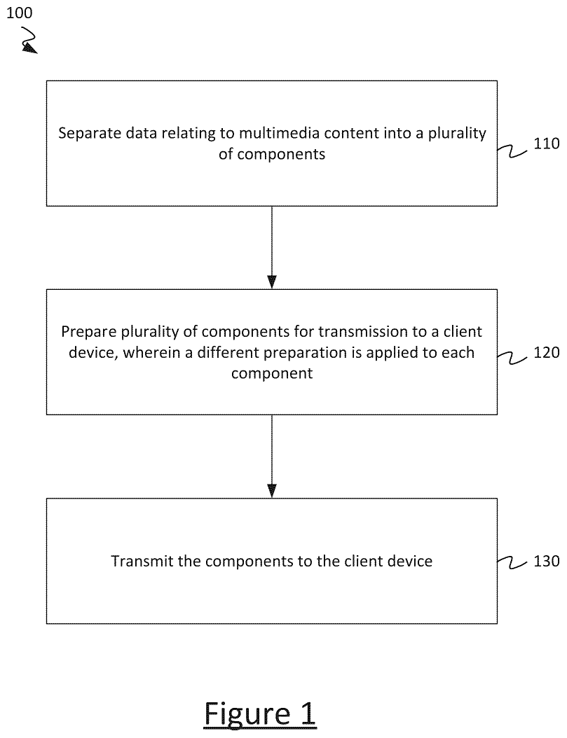

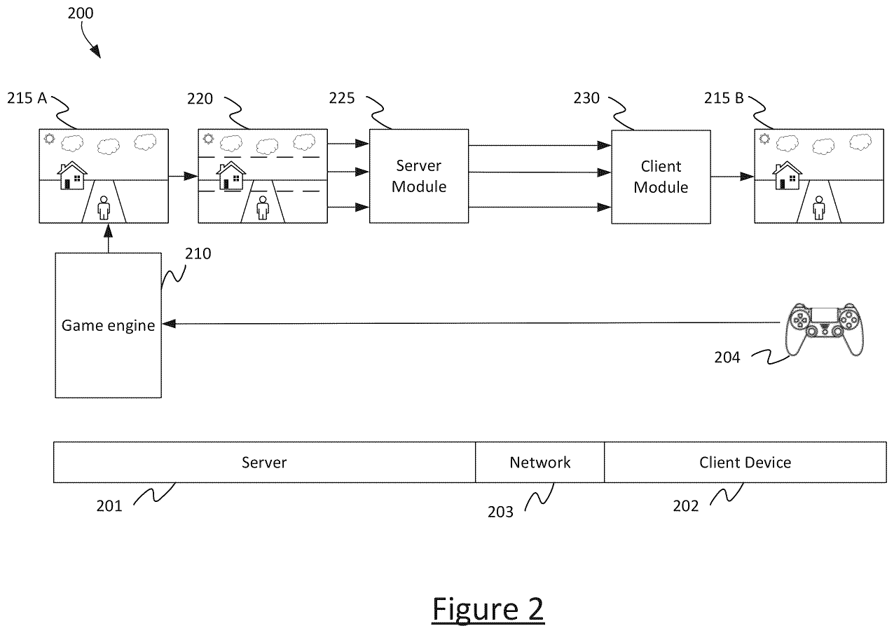

FIG. 1 illustrates a flow diagram of a method 100 for adaptively streaming media content and FIG. 2 shows schematically an example of a cloud gaming system 200 that may be used to execute the method 100. In FIG. 2, the cloud gaming system 200 is shown as comprising a server 201 that is in communication with a client device 202 via a communications network 203. FIGS. 1 and 2 will be described together below.

The steps of the method 100 are carried out at a server 201 that is remote to a client device 202. At the client device 202 multimedia content 215 B is displayed to a user. The remote server 201 stores and runs video games comprising data corresponding to the multimedia content 215. The server 201 comprises a game engine 210 which generates multimedia content 215 A to be separated into different components 220 and transmitted to the client device 202.

The server 201 is a remote server which may be a cloud server. A cloud server is a pooled, centralised server resource that is hosted and delivered over a network 203 and accessed on demand by multiple users. Cloud servers can perform all the functions of a traditional physical server, delivering processing power, storage and applications. Cloud servers can be located anywhere and deliver services remotely through a cloud computing environment. The cloud server is configured to provide a cloud game service comprising multimedia content 215 to individual client devices 202 and transmit game playing data generated according to the game. The cloud server includes at least a memory configured to store the game, a processor, and a server module 225 configured to communicate with client device 202 via the communications network 203. The communications network 203 preferably being the internet.

The server 201 may receive instructions from the client device 202, specifically from user inputs received by via an input device 204 which affects the game and the multimedia content 215 generated at the game engine 210. The server 201 transmits real-time game playing multimedia content 215 A as the prepared components to the client device 202 in streaming mode.

According to a first step, 110, data relating to multimedia content 215 is separated at the server 201 into a plurality of components. Each one of the plurality of components corresponds to one or more features of the multimedia content 215 A generated by the game engine 210. The features of the multimedia content 215 A include but are not limited to: sound data, image data, animation data, saliency data, etc.

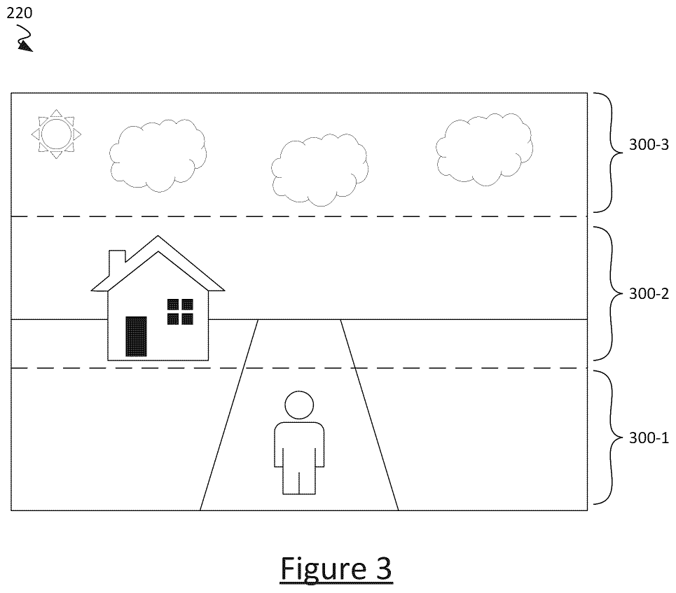

FIG. 3 illustrates an example image of a scene from a frame of streamed multimedia content 215 A generated by the game engine 210 and separated into three components: a foreground component 300-1, a “middle” ground (e.g. midground) component 300-2, and a background component 300-3.

Separation of the data into components can be achieved according to a variety of different ways. In the illustrated example of FIG. 3, separating the data includes segmenting data into different components comprising a foreground component 300-1, a midground component 300-2, and a background component 300-3. Background image information (and/or changes to that information), sound, speech, animation (i.e., foreground image information) could be separated into these components. It will be appreciated that FIG. 3 illustrates an example to be used to aid understanding of the present disclosure but that there are many ways in which the data of the multimedia content 215 A could be separated.

In other examples, the data can be separated into static components comprising static features and dynamic components comprising dynamic features (e.g. moving parts) of the multimedia content 215.

These two examples of component separation may not be mutually exclusive, for example a foreground component 300-1 may comprise dynamic components, and background components 300-3 may comprise static components. Alternatively, “foreground data” may be separated into a static foreground component and a dynamic foreground component, etc.

Alternative ways to separate data include separation by data type (e.g. a sound data component, an image data component, etc.). In addition, there may be more than one component per “category”. For example, image data may be separated into separate object data, sound data could be separated into “close” and “distant” sounds, etc.

Optionally, the plurality of components can be assigned a priority, for example a ranking in order of importance. Foreground and/or dynamic features which a user interacts with directly at the client device 202 can be assigned higher priorities, whilst background and/or static components can be assigned lower priorities.

Priorities provide a tool to determine which parts of the multimedia content 215 are to be favourably processed at the server 201 or at the client device 202, and/or which components are to be favourably streamed, for example when computing resources are limited. If an available bandwidth of a network connection between the server 201 and the client device 202 drops below a certain level, components could be processed in order of priority (from high to low) to ensure that the key features of the multimedia content 215 A are provided to the client device 202.

To save resources, in one example, some of the components may not be transmitted to the client device 202 and preparing may include tagging these components accordingly.

Optionally, the components could include a mask to block out certain areas of an image such as a foreground/midground/background as appropriate.

According to a second step 120, the plurality of components is prepared at the server module 225 for transmission to a client module 230 at the client device 202, wherein a different preparation is applied to each component. The server module 225 can perform a variety of different operations on the components to prepare them for transmission including but not limited to: encoding, rendering, compression, and encryption of the components.

Separating the data into components provides the first step towards treating the components differently. Being able to treat the components differently means that each component can be processed separately and, for example, compressed, rendered and encoded more efficiently. More “important data” such as foreground items, speech and sound can be given priority if the availability of resources is low. Background information may not change very rapidly for a given scene in a game so data and information relating to the background could be predicted (e.g. at the client device 202) based on a previous frame or a series of previous frames of the media content.

In one example, each of the components can be transmitted across the network 203 using a separate codec which is optimised for that component. A codec encodes or decodes the data stream. At the server 201, the data is encoded at the server module 225 for transmission across the network 203 and the encoded data is decoded at the client module 230 upon receipt at the client device 202.

In other examples, the plurality of components may be compressed by the server module 225 according to a different data compression ratio optimised for a respective component. Data compression ratio, also known as compression power, is a measurement of the relative reduction in size of data representation produced by a data compression algorithm. It is typically expressed as the division of uncompressed size by compressed size. Some components may comprise more data, therefore requiring higher compression. Alternatively, some types of data are not compressed as well as other types of data or cannot be as successfully decompressed so it can be advantageous to tailor the type of compression applied to a component dependent on the data/features comprised therein.

In some examples, different components of an image can be streamed, for example, at different resolutions. This may be particularly beneficial when separating the multimedia content 215 A into background 300-3, midground 300-2 and foreground 300-1 components. Advantages of streaming parts of the image at different resolutions may also be achieved for games that use foveated rendering.

Static and dynamic components of the multimedia content 215 A can be prepared differently at the server 201. Fast moving layers (e.g. dynamic layers) which have a potential to cause high latency can be sent from the server 201 in a more raw format (compared to static component) for the dynamic component to be processed primarily at the client device 202. Static layers can be more easily compressed and decompressed without losing information in transmission so components having these static elements (e.g. features) can be completed (e.g. rendered) at the server 201 and sent via codec without having a detrimental effect on latency and whilst providing a high quality image for the user.

The components of the multimedia content 215 A can be streamed with separate encoding for each component. Foreground, midground and background components 300-1, 300-2, 300-3 can be transmitted separately and with different compression rates. This means that foreground components 300-1, which may include more dynamic content requiring more processing, can be given priority in available computing resources.

In some examples, foreground, midground, and background components 300-1, 300-2, 300-3 are sent as linear files and then reconstructed at the client device 202 using positional information and standard rendering and/or buffering to complete the multimedia content 215 B. Linear files can be sent with information (e.g. positional information) for each component to enable it to be repositioned at the client device 202.

In difficult transmission environments, for example where available bandwidth drops below a predetermined level, prioritisations are made about which data is to be sent to the client device 202 for example based on priorities assigned to the components at the separation step 110.

In one example, foreground components are sent to the client device 202 and other components, such as background components, are predicted at the client device 202 based on previous frames of the multimedia content 215 B. Machine learning and other techniques may be used to predict this data.

In some examples, the server treats the multimedia content 215 A generated at the server 201 as an atlas and sends information in a per-pixel, tile-based approach. The “atlas” has all the information relating to pixel and tile information and computer resources required for that pixel or tile.

According to a third step 130, the plurality of prepared components is transmitted to the client device 202. Transmission occurs across a communication network 203, for example a wireless communication network 203 such as the internet.

In some examples, additional information can be sent to the client device 202, for example to communicate information about how to process the components at the client device 202. This can be sent in the form of a message. In one example, a compressed version of a map which indicates how the components fit together could be sent along with the transmitted components. In other examples, information concerning instructions for processing such as rendering and prediction could be included in the message.

The client device 202 may include, e.g. a video game playing device (games console), a smart TV, a set-top box, a smartphone, laptop, personal computer (PC), USB-streaming device (e.g. Chromecast), etc. The client device 202 receives components from the server 201, via the communications network 203, for example at a communication module 230. In some examples, the client device 201 receives components from the server 201 and performs further processing on the components and the data transmitted therewith.

In FIG. 2, the client device 202 is shown as being associated with an of input device 204. Users input signals via the input devices 204 to play the game. Signals received at the input device 204 affect the multimedia content 215 A, 215 B that is generated by the game engine 210. It will be appreciated that the input device 204 is an illustrative example and that different types of input devices may be provided. The input devices are in communication with the client device 202 via a wired or wireless connection.

The client device 202 comprises a communication interface for receiving user inputs generated at or via the input devices. It will be further appreciated that in some examples, user inputs may be generated at the client device 202 and not necessarily with a separate, standalone input device 204. For example, if the client device 202 is a smartphone or table with a touchscreen. User inputs can be communicated to the server 201 via the communications network 203 to inform the multimedia content 215 A to be generated.

At the client device 202, the plurality of components are received and processed by the client module 230 for reconstructing the multimedia content 215 B at the client device 202 for display to a user, e.g. a player of the game. The multimedia content 215 B corresponds to the multimedia content 215 A generated by the game engine 210 at the server 201. Whilst they may not be exactly the same due to the processing that takes places and losses within the system, the present disclosure helps to improve the similarity between the multimedia content 215 A generated at the server 201 and the reconstructed multimedia content 215 at the client device 202 and aims to improve the quality achieved at the client device 202. Reconstructing the multimedia content 215 B can include but is not limited to: decrypting, decoding, decompressing, rendering and re-positioning the components.

Some post-processing effects can be applied at the client device 202 to further reduce latency of transmission. Lighting effects, for example, can be applied and performed at the client device 202 to reduce latency. Lighting is also the last step to be applied to a visual scene so this needs to be performed last.

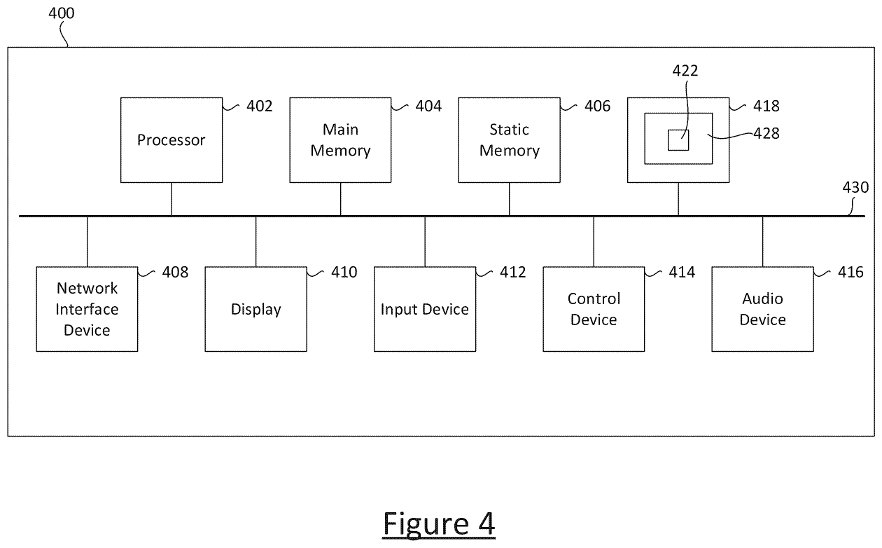

FIG. 4 illustrates a block diagram of one example implementation of a computing device 400 that can be used for implementing the steps indicated in FIG. 1 and explained throughout the detailed description. The computing device is associated with executable instructions for causing the computing device to perform any one or more of the methodologies discussed herein. The computing device 400 may operate in the capacity of the data model or one or more computing resources for implementing the data model for carrying out the methods of the present disclosure. In alternative implementations, the computing device 400 may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 400 includes a processing device 402, a main memory 404 (e.g., read-only memory (ROM), flash memory, dynamic random-access memory (DRAM) such as synchronous DRAM (SDRAM) or Rambus DRAM (RDRAM), etc.), a static memory 406 (e.g., flash memory, static random-access memory (SRAM), etc.), and a secondary memory (e.g., a data storage device 418), which communicate with each other via a bus 430.

Processing device 402 represents one or more general-purpose processors such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute the processing logic (instructions 422) for performing the operations and steps discussed herein.

The data storage device 418 may include one or more machine-readable storage media (or more specifically one or more non-transitory computer-readable storage media) 428 on which is stored one or more sets of instructions 422 embodying any one or more of the methodologies or functions described herein. The instructions 422 may also reside, completely or at least partially, within the main memory 404 and/or within the processing device 402 during execution thereof by the computer system 400, the main memory 404 and the processing device 402 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

The disclosure can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing disclosure has been described in some detail, it will be apparent that certain changes and modifications can be practiced within the scope of the appended claims. Accordingly, the present embodiments are to be considered as illustrative and not restrictive.

1. A method of adaptively streaming multimedia content performed at a server, the method comprising:
separating data relating to the multimedia content into a plurality of components, each of the components corresponding to one or more features of the multimedia content;
preparing the plurality of components for transmission to a client device, wherein a different preparation is applied to each component depending on the one or more features of a respective component; and
transmitting the prepared components from the server to the client device.

2. The method of claim 1, wherein preparing the components for transmission comprises applying a different data compression ratio to the data of each of the plurality of components.

3. The method of claim 1, wherein preparing the components for transmission comprises rendering an image based on the data of the respective component, wherein rendered images of the plurality of components each have a different resolution.

4. The method of claim 1, wherein preparing the components for transmission comprises adding information to a transmission packet concerning the respective component to the plurality of components.

5. The method of claim 1, further comprising transmitting a message from the server to the client device comprising information on how to construct the multimedia content at the client device.

6. The method of claim 1, wherein the plurality of components comprises one or more of:
a foreground component comprising features for display in a foreground of the multimedia content;
a midground component comprising features for display in a midground of the multimedia content; and/or
a background component comprising features for display in a background of the multimedia content.

7. The method of claim 1, wherein the plurality of components comprise:
a static component comprising static features; and
a dynamic component comprising dynamic features.

8. The method of claim 7, wherein the static component is rendered at the server and the dynamic component is transmitted to the client device for rendering at the client device.

9. The method of claim 1, further comprising assigning a priority to each one of the plurality of components and preparing the components for transmission based on their assigned priorities.

10. The method of claim 9, further comprising allocating computing resources to the components based on the priority.

11. The method of claim 1, further comprising receiving, at the client device, the components of the multimedia content; and constructing the multimedia content at the client device.

12. The method of claim 11, wherein constructing comprises one or more of: decrypting, decompressing, decoding, repositioning and/or rendering the plurality of components.

13. The method of claim 10, further comprising applying post-processing effects to the constructed multi-media content.

14. The method of claim 1, further comprising predicting, at the client device, data relating to components that are not received at the client device.

15. The method of claim 1, wherein the preparation depends on a bandwidth available between the server and the client device.

16. The method of claim 1, wherein each of the components is transmitted using a different codec.

17. A server comprising:
a memory; and
one or more processors configured to implement a method of adaptively streaming multimedia content performed at a server, the method comprising:
separating data relating to the multimedia content into a plurality of components, each of the components corresponding to one or more features of the multimedia content;
preparing the plurality of components for transmission to a client device, wherein a different preparation is applied to each component depending on the one or more features of a respective component; and
transmitting the prepared components from the server to the client device.

18. The server according to claim 17, wherein the server is cloud based.
